(19) United States
(12) Patent Application Publication
(10) Pub. No.: US 2011/0022446 A1
(43) Pub. Date: Jan. 27, 2011

(54) SIMPLIFIED REBATE REDEMPTION SYSTEM

(76) Inventors: Conrad R. Carney, II, Lexington, KY (US); James H. Johnson, JR., Lexington, KY (US)

Correspondence Address: KING & SCHICKLI, PLLC, 247 NORTH BROADWAY, LEXINGTON, KY, 40507, US

(21) Appl. No.: 12/841,366

(22) Filed: Jul. 22, 2010

Related U.S. Application Data
(60) Provisional application No. 61/227,533, filed on Jul. 22, 2009.

(51) Int. Cl. G06Q 30/00

(52) U.S. Cl. 705/14.1

(57) ABSTRACT

A method of simplified rebate redemption for a good or service purchased by a consumer comprises using a mobile communication device of a consumer to complete the rebate redemption. Preferably the mobile communication device utilized is a mobile telephone having text messaging capability. Thus, the method includes sending a receipt, bar code information and redemption offer information to the entity offering the rebate using the text messaging capability of a mobile telephone of a consumer purchasing the good or service for which the rebate is offered.

This application claims priority to U.S. Provisional Patent Application Ser. No. 61/227,533 filed 22 Jul. 2009, the entire disclosure of which is incorporated herein by reference.

### TECHNICAL FIELD AND INDUSTRIAL APPLICABILITY OF THE INVENTION

The present invention relates generally to the marketing field and, more particularly, to a method of simplified rebate redemption utilizing mobile phone text messaging.

### BACKGROUND OF THE INVENTION

The marketing of goods and services by means of offering rebates is well known in the art. Unfortunately, many consumers find the process of redeeming rebates difficult, confusing and inconvenient. Most require the consumer/purchaser to gather and send various pieces of information to the manufacturer or retailer offering the rebate. Such information often includes a bar code from the box the product was packaged in, a receipt from the store and various personal information of the purchaser. For many this is a time consuming hassle.

The present invention relates to a new and improved method of simplified rebate redemption using a mobile phone. Such a system allows the consumer to quickly and easily complete the rebate redemption process.

### SUMMARY OF THE INVENTION

In accordance with the purposes of the present invention as described herein, a method is provided allowing one to obtain rebate redemption for the purchase of a good or service in a quick, simple and convenient manner. The method may be broadly described as comprising the step of using a mobile communication device, such as a mobile telephone with text messaging ability to complete the rebate redemption. The method includes transmitting a receipt for the purchase of a good or service by the consumer to the mobile communication device of the consumer. Further, the method includes sending a bar code and receipt for the purchased good or service to the entity offering the rebate. This is in addition to sending any consumer information necessary for rebate redemption to the entity offering the rebate. Such consumer information includes, for example, name, address and contact information for the consumer. The method may also include the transmitting of the redemption offer to the consumer with the receipt for the purchase of the good or service. That redemption offer may then also be sent by the consumer to the entity offering the rebate using the text messaging feature of the mobile phone.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### DETAILED DESCRIPTION OF THE PREFERRED EMBODIMENTS OF THE INVENTION

The present method of simplified rebate redemption for a good or service purchased by a consumer may be broadly described as comprising the step of using a mobile communication device so that the consumer may complete the rebate redemption. More specifically, the method includes the steps of transmitting a receipt for the purchase of a good or service by the consumer to the mobile communication device of the consumer. The transmitting of the receipt is typically done by the retailer or business from whom the good or service was purchased by the consumer. Further, the method includes sending the bar code and receipt for the purchased good or service to the entity offering the rebate. In this case it is the consumer that sends the bar code and receipt and the entity offering the rebate may, for example, be the manufacturer of the good, the provider of the service or the retailer, wholesaler or store from which the good or service was purchased. In addition, the consumer sends any consumer information necessary for rebate redemption to the entity offering the rebate. That consumer information may, for example, comprise the name, residence address, phone number, e-mail address and combinations thereof of the consumer. Further the method includes sending the rebate to the consumer.

In one alternative embodiment of the present invention the method includes also transmitting a redemption offer to the consumer with the receipt for the purchase of the good or service. Typically the redemption offer is transmitted by the store or retailer who sold the good or service to the consumer.

In one particularly useful embodiment of the present invention, the mobile communication device utilized for completing the rebate redemption is a mobile telephone with text messaging capability of a type well known in the art. In this embodiment the method includes sending the receipt, bar code information and redemption offer information to the mobile telephone of a consumer using the text messaging capability of that telephone. Subsequently, the consumer uses the text messaging capability of the mobile telephone to send that information on to the entity offering the rebate. This paperless exchange of the necessary rebate information may be done quickly and easily and in a far more convenient manner than the current state of the art rebate process. Accordingly, it is far more appealing to the consumer and represents a significant advance in the art.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method of simplified rebate redemption for a good or service purchased by a consumer, comprising:
using a mobile communication device of said consumer to complete said rebate redemption.

2. The method of claim 1, including transmitting a receipt for purchase of a good or service by said consumer to said mobile communication device of said consumer.

3. The method of claim 2, including sending barcode and receipt for purchased good or service to entity offering rebate.

4. The method of claim 3, including sending any consumer information necessary for rebate redemption to entity offering rebate.

5. The method of claim 4, including selecting consumer information from a list of consumer information including name, residence address, phone number, e-mail address and combinations thereof.

6. The method of claim 4, including sending rebate to said consumer.

7. The method of claim 2, including transmitting redemption offer to said consumer with said receipt for purchase of said good or service.

8. The method of claim 7, including sending said receipt, bar code information and redemption offer information to said entity offering said rebate using text messaging capability of a mobile telephone of said consumer.
